(19) United States
(12) Patent Application Publication
(10) Pub. No.: US 2025/0209550 A1
(43) Pub. Date: Jun. 26, 2025

(54) INFORMATION PROCESSING APPARATUS AND METHOD OF OPERATING INFORMATION PROCESSING APPARATUS

(71) Applicant: TOYOTA JIDOSHA KABUSHIKI KAISHA, Aichi-ken (JP)

(72) Inventor: Hiroshi OKI, Seto-shi (JP)

(21) Appl. No.: 18/986,702

(22) Filed: Dec. 19, 2024

(30) Foreign Application Priority Data
Dec. 21, 2023 (JP) 2023-215938

(51) Int. Cl. G06Q 50/06; G06Q 10/02; G06Q 30/0201; G06Q 30/0283

(52) U.S. Cl. CPC G06Q 50/06; G06Q 10/02; G06Q 30/0206; G06Q 30/0283

(57) ABSTRACT

An information processing apparatus includes a communication interface, and a controller configured to communicate using the communication interface, determine, based on a prediction of amounts of power to be consumed in a jurisdiction in a predetermined time period including a plurality of time units, amounts of power to be purchased from a grid, and amounts of power to be generated or discharged by a distributed power source, for covering the amounts to be consumed, and after transmitting information for reserving the amounts to be purchased, increase an amount of power to be generated in a first time unit in a case in which a consumed amount corresponding to the first time unit is predicted to be less than a criterion.

### CROSS-REFERENCE TO RELATED APPLICATION

This application claims priority to Japanese Patent Application No. 2023-215938, filed on Dec. 21, 2023, the entire contents of which are incorporated herein by reference.

### TECHNICAL FIELD

The present disclosure relates to an information processing apparatus and a method of operating an information processing apparatus.

### BACKGROUND

The concept of a community Energy Management System (EMS) is being developed in communities managed by local governments, companies, and the like for management, as a whole, of the charging and discharging of various power sources scattered throughout the community, the power supply from the power grid (hereinafter referred to simply as the grid) of an electricity provider, and the power demand occurring within the community. Various technologies have been proposed for managing the power supply and demand in a community. For example, Patent Literature (PTL) 1 discloses a technology for planning to adjust at least one of a consumption time period and consumed electrical energy for adjustable business when the power demand can exceed a target value.

### CITATION LIST

### Patent Literature

PTL 1: JP 2015-149827 A

### SUMMARY

A means of avoiding with more certainty a shortfall in the amount of power to be purchased that has been reserved for the grid is required.

The present disclosure relates to an information processing apparatus or the like, which enables the avoidance of a shortfall in the amount of power to be purchased that has been reserved for the grid with more certainty.

An information processing apparatus in the present disclosure includes:
a communication interface; and
a controller configured to:
   communicate using the communication interface;
   determine, based on a prediction of amounts of power to be consumed in a jurisdiction in a predetermined time period including a plurality of time units, amounts of power to be purchased from a grid, and amounts of power to be sold to the grid, or amounts of power to be generated, discharged, or charged by a distributed power source, for covering the amounts to be consumed as well as selling generated surplus power to the grid; and
   after transmitting information for reserving the amounts to be purchased and the amounts to be sold, increase respective amounts of power to be generated and discharged in a first time unit or decrease an amount of power to be charged in the first time unit in a case in which a consumed amount corresponding to the first time unit is predicted to be less than a criterion, and decrease the respective amounts of power to be generated and discharged in the first time unit or increase the amount of power to be charged in the first time unit in a case in which the consumed amount corresponding to the first time unit is predicted to be greater than the criterion.

A method of operating an information processing apparatus in the present disclosure includes:
determining, based on a prediction of amounts of power to be consumed in a jurisdiction in a predetermined time period including a plurality of time units, amounts of power to be purchased from a grid, and amounts of power to be sold to the grid, or amounts of power to be generated, discharged, or charged by a distributed power source, for covering the amounts to be consumed as well as selling generated surplus power to the grid; and
after transmitting information for reserving the amounts to be purchased and the amounts to be sold, increasing respective amounts of power to be generated and discharged in a first time unit or decreasing an amount of power to be charged in the first time unit in a case in which a consumed amount corresponding to the first time unit is predicted to be less than a criterion, and decreasing the respective amounts of power to be generated and discharged in the first time unit or increasing the amount of power to be charged in the first time unit in a case in which the consumed amount corresponding to the first time unit is predicted to be greater than the criterion.

According to the information processing apparatus or the like in the present disclosure, it is possible to avoid a shortfall in the amount of power to be purchased that has been reserved for the grid with more certainty.

### BRIEF DESCRIPTION OF THE DRAWINGS

In the accompanying drawings:

FIG. 1 is a diagram illustrating an example of a configuration of a power management system;

FIG. 2 is a flowchart illustrating an example of operations of a server apparatus; and

FIG. 3 is a diagram illustrating a schematic example of a power supply plan.

### DETAILED DESCRIPTION

Embodiments are described below.

### [Example of Configuration of System]

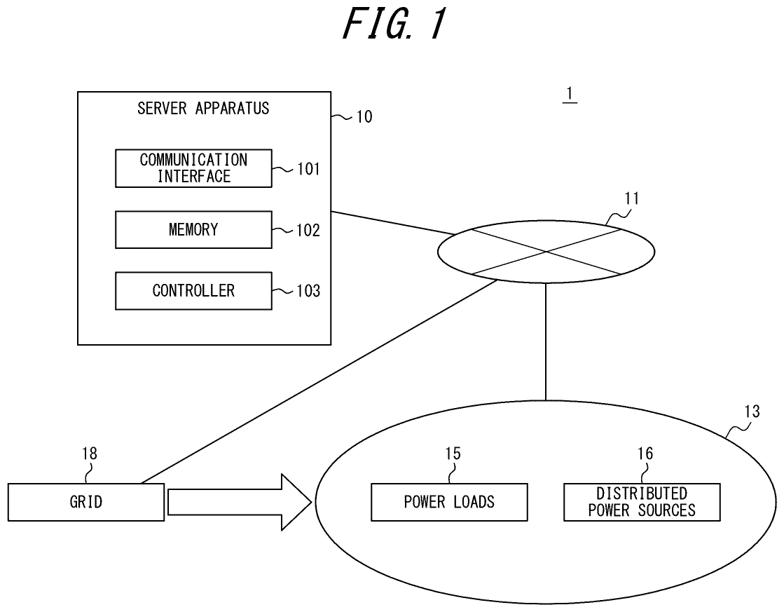

FIG. 1 is a diagram illustrating an example of a configuration of a power management system 1 according to an embodiment. The power management system 1 is a system for supporting the efficient power purchase by a community from the grid of an electricity provider. The community is a jurisdiction managed by a municipality, company, or the like, and is a unit of any city block or region. The power management system 1 includes one or more server apparatuses 10 and energy resources 13 within the community, which are communicably connected to each other via a network 11. The server apparatus 10 corresponds to the “information processing apparatus” of the present embodiment. The energy resources 13 include power loads 15 and distributed power sources 16 distributed throughout the community. The power consumed by the power loads 15 is supplied by a grid 18 or by the distributed power sources 16.

The server apparatus 10 is, for example, a server computer that belongs to a cloud computing system or other computing system and operates as a community EMS (CEMS) server. The network 11 is, for example, the Internet, but may include an ad hoc network, a LAN, a metropolitan area network (MAN), or other networks, or any combination thereof. The power loads 15 are electric appliances, lights, air conditioners, or the like installed in residences, commercial facilities, or the like. The power loads 15 may include battery electric vehicles (BEVs), hybrid electric vehicles (HEVs), or the like driven by battery power and charging stations for such vehicles. The distributed power sources 16 include solar, wind, and other alternative energy-based generation devices; fuel cells; storage batteries; and the like. The distributed power sources 16 may include batteries for BEVs, HEVs, etc., and a discharge station to discharge the battery power. The operation of the power loads 15 and distributed power sources 16 is managed or controlled by power conditioners, smart meters, and the like that are connected to the network 11 and are configured to communicate information. Information on the operation of the power loads 15 and distributed power sources 16 is transmitted and received to and from the server apparatus 10 via the network 11 by the power conditioners, smart meters, and the like.

In the present embodiment, the server apparatus 10 includes a communication interface 101 and a controller 103 that communicates using the communication interface 101. The controller 103 determines, based on a prediction of amounts of power to be consumed in a jurisdiction in a predetermined time period (e.g., 24 hours, hereinafter called the target period) including a plurality of time units (e.g., 0.5 to 1 hour units), amounts of power to be purchased from the grid 18, and amounts of power to be sold to the grid 18, or amounts of power to be generated, discharged, or charged by the distributed power sources 16, for covering the amounts to be consumed as well as selling generated surplus power to the grid 18, and after transmitting information for reserving the amounts to be purchased and the amounts to be sold, increases respective amounts of power to be generated and discharged in a first time unit or decreases an amount of power to be charged in the first time unit in a case in which a consumed amount corresponding to the first time unit is predicted to be less than a criterion, and decreases the respective amounts of power to be generated and discharged in the first time unit or increases the amount of power to be charged in the first time unit in a case in which the consumed amount corresponding to the first time unit is predicted to be greater than the criterion. When the community reserves the purchase of power from the grid 18 for a target period at least a certain time (e.g., one day) in advance of the target period, an additional charge may be imposed for changes in the amount of power purchased after the reservation, depending on the contract with the electricity provider. In this regard, according to the present embodiment, by storing the power generated by the distributed power sources 16 in time units where the amounts to be consumed are relatively small, it is possible to have power available for use in time units where the amounts to be consumed are relatively large and the power supply may be tight. Thus, it is possible to avoid a shortfall in the amount of power to be purchased that has been reserved for the grid 18 with more certainty.

### [Example of Configuration of Server Apparatus]

The server apparatus 10 includes the communication interface 101, a memory 102, and the controller 103. The server apparatus 10 is, for example, a single computer. The server apparatus 10 may be two or more computers that are communicably connected to each other and operate in cooperation. In this case, the components can be arranged among two or more computers as appropriate.

The communication interface 101 includes one or more interfaces for communication. The interface for communication is, for example, a LAN interface. The communication interface 101 receives information to be used for the operations of the server apparatus 10 and transmits information obtained by the operations of the server apparatus 10. The server apparatus 10 is connected to the network 11 by the communication interface 101 and communicates information with the energy resources 13 via the network 11.

The memory 102 includes, for example, one or more semiconductor memories, one or more magnetic memories, one or more optical memories, or a combination of at least two of these types, to function as main memory, auxiliary memory, or cache memory. The semiconductor memory is, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 102 stores information to be used for the operations of the server apparatus 10 and information obtained by the operations of the server apparatus 10.

The controller 103 includes one or more processors, one or more dedicated circuits, or a combination thereof. The processor is a general purpose processor, such as a central processing unit (CPU), or a dedicated processor, such as a graphics processing unit (GPU), specialized for a particular process. The dedicated circuit is, for example, a field-programmable gate array (FPGA), an application specific integrated circuit (ASIC), or the like. The controller 103 executes information processing related to operations of the server apparatus 10 while controlling components of the server apparatus 10.

The functions of the server apparatus 10 are realized by a processor included in the controller 103 executing a control program. The control program is a program for causing a computer to execute the processing of steps included in the operations of the server apparatus 10, thereby enabling the computer to realize the functions corresponding to the processing of the steps. That is, the control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10 and be read from the medium by the server apparatus 10.

### [Example of Operations of Server Apparatus]

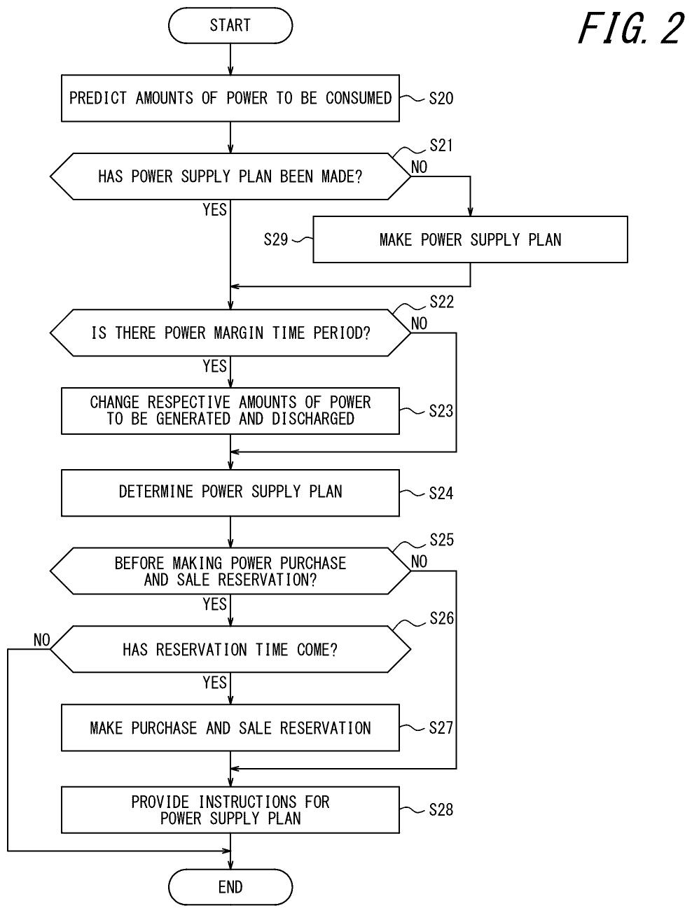

FIG. 2 is a flowchart illustrating an example of the operation procedures for the server apparatus 10. Each step illustrated in FIG. 2 is executed by the controller 103. The procedures in FIG. 2 are, for example, performed in any cycle, e.g., 30-minute cycles, starting at any time before the start of the electricity purchase market each day.

In step S20, the controller 103 predicts amounts of power to be consumed by the community for the period of interest. The period covered is, for example, the 24-hour period from 0:00 to 24:00 two days after the current date. The controller 103 acquires power information from the energy resources 13 and predicts the amounts of power to be consumed based on the power information. The power information is the history of the amounts of power consumed by the power loads 15 and the amounts of power supplied by the distributed power sources 16 over the previous one to several days, for example. The amounts of power consumed are the electrical energy supplied from the grid 18 and consumed by the power loads 15. The amounts of power supplied are the electrical energy that is generated by a power generation apparatus, or discharged from a storage battery, included in the distributed power sources 16 and is supplied to the energy resources 13. The controller 103 predicts with any algorithm the amounts of power to be consumed using, for example, the average over several days of the amounts of power consumed, the time-weighted average, etc.

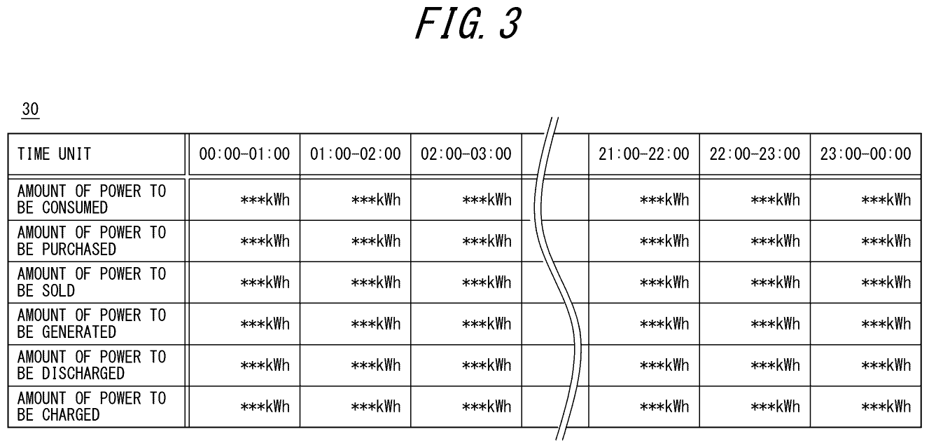

In step S21, the controller 103 confirms whether a power supply plan has been made. The prepared power supply plan is stored in the memory 102. In a case in which it has been made (Yes), the controller 103 proceeds to step S22. If it has not been made (No), the controller 103 proceeds to step S29 to create the power supply plan. For example, the controller 103 determines the amounts of power to be purchased, generated, discharged, or charged for the period of interest using any algorithm based on the power information acquired from the energy resources 13. The power supply plan, for example, as illustrated in Table 30 in FIG. 3, has values of an amount of power to be consumed, an amount of power to be purchased, an amount of power to be generated, an amount of power to be discharged, or an amount of power to be charged (all in kWh, for example) at each of hourly time units “00:00-01:00”, “01:00-02:00”, “02:00-03:00”, . . . “21:00-22:00”, “22:00-23:00”, and “23:00-24:00”. For each time unit, the controller 103 determines the amounts of power to be purchased, sold, generated, or charged/discharged that minimize the following objective function F, provided that the sum of the amounts of power to be purchased, generated, and discharged exceeds the predicted amount of power to be consumed.

F=KPI×α+IBC×β
KPI is the cost of generating and charging/discharging power offset by the revenue from the sale of surplus power,
IBC is the cost of imbalance for additional power purchases,
α and β are coefficients (α>β and α+β=1)

In step S22, the controller 103 determines the existence of power margin time period in the power supply plan. The power margin time period is the time unit in which power consumption is less than any criterion. The any criterion is, for example, the electrical energy such that the amount to be consumed can be covered without adding the amount of power to be discharged by storage batteries that were scheduled to be discharged in a given time unit. Specifically, the criterion is any value, such as 80% to 90% of the total amount of power to be purchased and generated, which is the amount of power supplied minus the amount of power to be discharged by storage batteries in a given time unit. Note that time units with power consumption above the criterion correspond to power crunch hours. In a case in which there is a power margin time period (Yes), the controller 103 proceeds to step S23. In a case in which there is no power margin time period (No), the controller 103 omits step S23 and proceeds to step S24.

In step S23, the controller 103 increases the amount of power to be generated during the power margin time period. The range of increase can be set freely. For example, the increase can be any value, such as 80% to 90% of the smaller of electrical energy that can be charged by the rechargeable storage batteries included in the distributed power sources 16 and electrical energy that can be additionally generated by the generating facility. A rechargeable storage battery is an idling storage battery or a storage battery that was scheduled to be discharged in that unit of time. For example, when deriving the amount of power to be generated by a photovoltaic power generation facility, the controller 103 can acquire information on the hours of sunlight in the power margin time period during the subject period from a server that provides weather information and derive the amount of power to be generated according to the hours of sunlight. If multiple power margin time periods are identified, the controller 103 may increase the amount of power to be generated at each power margin time period, or it may increase the amount of power to be generated at any of the unit hours, for example, at the unit hour with the lowest predicted amount to be consumed.

In step S24, the controller 103 determines the power supply plan. The controller 103 stores the determined power supply plan in the memory 102.

In step S25, the controller 103 confirms whether it is before making a power purchase reservation. In a case in which it is before a reservation (Yes), the controller 103 proceeds to step S26. If it is not before the reservation (No), i.e., the reservation has been made, the controller 103 proceeds to step S28.

In step S26, the controller 103 checks whether the reservation time for power purchase reservation has come. The reservation time is, for example, noon two days before the subject period. The controller 103 may determine that the reservation time has come on the condition that the current time is included in any time up to any period of time (e.g., one hour) before the reservation time. In a case in which the reservation time has come (Yes), the controller 103 proceeds to step S27. If the reservation time has not come (No), the controller 103 terminates this process.

In step S27, the controller 103 transmits reservation information to reserve the amounts of power to be purchased included in the power supply plan. The controller 103, for example, transmits the reservation information to the server of the electricity provider. In doing so, a reservation is made for the purchase of power for the period in question.

In step S28, the controller 103 transmits instructions to execute the power supply plan. The controller 103 then terminates the procedures of FIG. 2. The instructions for executing the power supply plan include information identifying the amounts of power per time unit to be purchased and sold, generated, or charged/discharged, and the respective distributed power sources 16 that are to generate and charge/discharge power. In addition, such instructions include information identifying the amounts of power to be generated or charged during the power margin time period, as well as the respective distributed power sources 16 that will generate and charge power. In response to such instructions, the distributed power sources 16 generate, discharge, and charge power, so that surplus power can be stored in storage batteries during power margin time period to provide for power shortages during tight power periods. Thus, it is possible to avoid a shortfall in the amount of power to be purchased that has been reserved for the grid 18 with more certainty.

While embodiments have been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. An information processing apparatus comprising:
a communication interface; and
a controller configured to:
communicate using the communication interface;
determine, based on a prediction of amounts of power to be consumed in a jurisdiction in a predetermined time period including a plurality of time units, amounts of power to be purchased from a grid, and amounts of power to be sold to the grid, or amounts of power to be generated, discharged, or charged by a distributed power source, for covering the amounts to be consumed as well as selling generated surplus power to the grid; and
after transmitting information for reserving the amounts to be purchased and the amounts to be sold, increase respective amounts of power to be generated and discharged in a first time unit or decrease an amount of power to be charged in the first time unit in a case in which a consumed amount corresponding to the first time unit is predicted to be less than a criterion, and decrease the respective amounts of power to be generated and discharged in the first time unit or increase the amount of power to be charged in the first time unit in a case in which the consumed amount corresponding to the first time unit is predicted to be greater than the criterion.

2. The information processing apparatus according to claim 1, wherein the controller is configured to transmit instructions to the distributed power source to generate, discharge, and charge the increased or decreased amounts of power to be generated, discharged, and charged.

3. The information processing apparatus according to claim 1, wherein the controller is configured to transmit instructions to a storage battery to store an amount of power to be generated that corresponds to the first time unit.

4. The information processing apparatus according to claim 1, wherein the controller is configured to determine the amounts of power to be generated, discharged, or charged, the amounts to be purchased, or the amounts to be sold so as to minimize a function that calculates a total cost by using a cost of power generation at the amounts of power to be generated, and a cost of the amounts to be purchased and revenue from the amounts to be sold as variables.

5. A method of operating an information processing apparatus comprising:
determining, based on a prediction of amounts of power to be consumed in a jurisdiction in a predetermined time period including a plurality of time units, amounts of power to be purchased from a grid, and amounts of power to be sold to the grid, or amounts of power to be generated, discharged, or charged by a distributed power source, for covering the amounts to be consumed as well as selling generated surplus power to the grid; and
after transmitting information for reserving the amounts to be purchased and the amounts to be sold, increasing respective amounts of power to be generated and discharged in a first time unit or decreasing an amount of power to be charged in the first time unit in a case in which a consumed amount corresponding to the first time unit is predicted to be less than a criterion, and decreasing the respective amounts of power to be generated and discharged in the first time unit or increasing the amount of power to be charged in the first time unit in a case in which the consumed amount corresponding to the first time unit is predicted to be greater than the criterion.
